(19) United States
(12) Patent Application Publication
(10) Pub. No.: US 2007/0202298 A1
(43) Pub. Date: Aug. 30, 2007

(54) Method of producing porous sheet and porous sheet obtained by the production method

(76) Inventors: Hiroyuki Iida, Ibaraki-shi (JP); Satoshi Sakuma, Ibaraki-shi (JP); Youji Uchida, Ibaraki-shi (JP); Junichi Nakazono, Ibaraki-shi (JP); Ryouichi Matsushima, Ibaraki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/710,888

(22) Filed: Feb. 26, 2007

(30) Foreign Application Priority Data
Feb. 27, 2006 (JP) 2006-50717

(51) Int. Cl. G11B 5/64

(52) U.S. Cl. 428/141

(57) ABSTRACT

A method of producing a porous sheet, which comprises the steps consisting of preparing a dispersion having ultra-high-molecular-weight polyethylene particles dispersed in a solvent, applying the dispersion onto a film to form a coating layer thereon, sintering the coating layer, and removing the solvent contained in the coating layer.

### FIELD OF THE INVENTION

The present invention relates to a method of producing a porous sheet and a porous sheet obtained by the production method and in particular to a method of producing a porous sheet applicable to suction delivery, vacuum adsorption fixation etc. in production etc. of a glass plate for liquid crystal, a semiconductor wafer or a multilayer ceramic capacitor and a porous sheet obtained by the production method.

### BACKGROUND OF THE INVENTION

In the case of an electronic part such as a ceramic capacitor constituted by laminating a dielectric sheet, a plastic porous sheet serving as a sheet for suction and fixation for delivery is used as an additional laminated member for suction and fixation for delivery of the dielectric sheet.

As the porous sheet, a porous sheet consisting of ultrahigh-molecular-weight polyethylene having an average molecular weight of 500,000 or more (referred to hereinafter as “UHMWPE”) is proposed to be used in consideration of air permeability, rigidity, and cushioning properties.

Generally, the porous sheet consisting of UHMWPE is produced by charging a mold with UHMWPE and then subjecting it to sintering etc. However, this method constitutes batch production and cannot produce a continuous porous sheet successively.

Accordingly, the applicant has previously proposed a method of producing a continuous porous sheet characterized in that UHMWPE powder filled in a mold is sintered with heated water vapor, then cooled and cut (see, for example, JP-B 5-66855).

The porous sheet obtained by this method is continuous and is thus characterized by being usable in various applications, highly strong, and excellent in air permeability.

The porous sheet produced by this method is about 2.0 μm in surface roughness. This is attributable to cutting conducted in the production process. For example, when a porous sheet is produced using fine particles having an average particle diameter of 30 μm or less, there are problem such as generation of pinholes and formation of cracks during filling and after molding, thus making molding difficult.

As a countermeasure against surface roughness, therefore, there are proposed methods of smoothing a surface by lamination with a plastic film and subsequent heating (see, for example, JP-A 09-174694 and JP-A 2001-28390). These methods can be used to improve surface smoothness. At present, however, there is demand for further improvement of surface smoothness.

As a method of molding small-diameter particles, there is disclosed a method which comprises coating a carrier sheet with a dispersion having plastic particles in a solvent, drying it to form a coating thereon, then fusing contact points of the particles, and releasing the coating from the carrier sheet to give a porous sheet (see, for example, JP-A 2001-172577).

In the method described above, particles of small diameter can be formed into a sheet, but this sheet has a disadvantage of lower strength than that of a porous sheet produced by cutting. In addition, a thick sheet of greater than 1 mm in thickness, for example, is hardly produced by the production method.

A solvent having a significantly lower boiling point than the melting point of the particles is used in this system, and thus the solvent has been volatilized when the particles are fused and sintered. When sintered in such a state, the particles are fluidized to fail to retain their original spherical form. As a result, the particles have been crushed on the surface of a porous sheet produced by such a method, to cause shape deformation, thereby reducing pore diameters on the surface. As a result, the inhibition of air permeability is caused.

JP-A 2006-26981 describes a method which comprises dispersing plastic particles in a solvent having a boiling point higher than the melting point of the particles and forming a layer of the particles on an UHMWPE sheet of relatively high strength. According to this method, a high-strength sheet of small pore diameter can be produced. In this method, however, the UHMWPE sheet is used as a support layer, and thus the sheet is hardly thinned. It is therefore difficult to prepare a sheet of high air permeability

### SUMMARY OF THE INVENTION

The present invention was made in view of the problem described above, and the object of the present invention is to provide a method of producing a porous sheet excellent in surface smoothness and air permeability and capable of being produced continuously in a continuous length, as well as a porous sheet obtained by the production method.

The present inventors extensively studied a sheet for suction and fixation and a method of producing the same in order to achieve the above object. As a result, the inventors found that the object can be achieved by adopting the constitution described below, thus arriving at completion of the present invention.

To solve the problem described above, the method of producing a porous sheet according to the present is a method of producing a porous sheet, which comprises the steps consisting of preparing a dispersion having ultra-high-molecular-weight polyethylene particles dispersed in a solvent, applying the dispersion onto a film to form a coating layer thereon, sintering the coating layer, and removing the solvent contained in the coating layer.

According to the method described above, there can be obtained a porous sheet having a microstructure with the shape of ultrahigh-molecular-weight polyethylene particles almost maintained with adjacent particles heat-fused with one another at their contact sites and non-contact sites serving as pores. That is, the method described above can give a porous sheet having a structure with the shape of ultrahigh-molecular-weight polyethylene particles maintained without crushing. As a result, the porous sheet excellent in air permeability can be produced as an adsorption fixation sheet for adsorption fixation of a member to be adsorbed. The porous sheet having the structure described above is contacted not via surface contact but via multipoint contact with a member to be adsorbed, and can thus be made excellent in releasability by reducing the effective contact area with a member to be adsorbed. Further, even if a member to be adsorbed is very thin, a porous sheet which upon release therefrom, can prevent breakage, flaw etc. of the member can be produced.

The porous sheet though having a single-layer structure not having a support etc. has high strength and is thus endowed with sufficient strength as an adsorption fixation sheet even if the sheet is relatively thin. The fact that the sheet is thin is very important for conferring high air permeability thereon and is more preferable for the adsorption fixation sheet. A relatively thick sheet can also be produced in this system.

The ultra-high-molecular-weight polyethylene particles used are preferably those having an average particle diameter of 100 μm or less.

A porous sheet with improvement in surface smoothness can thereby be produced. That is, even if a member to be adsorbed is significantly flexible, the porous sheet upon suction fixation of the member to be adsorbed can prevent the surface state thereof from shape transferring onto the member to be adsorbed.

The solvent used has preferably a boiling point higher than the melting point of the ultra-high-molecular-weight polyethylene particles and is low solubility (poor solvent) with the ultra-high-molecular-weight polyethylene particles.

The porous sheet of the present invention is excellent in surface smoothness because the surface roughness (Ra) is 0.5 μm or less according to the constitution described above. The porous sheet is a layer constituted by containing ultrahigh-molecular-weight polyethylene particles and can thus be made excellent in abrasion resistance and impact resistance with low friction coefficient. For adsorption fixation of a member to be adsorbed, the porous sheet can be contacted with the member not via surface contact but via multipoint contact. By so doing, the effective contact area of the porous sheet with a member to be adsorbed can be reduced to improve the releasability thereof from the member adsorbed and the air permeability of the porous sheet. As a result, the porous sheet can, upon release, prevent breakage, flaw etc. of the member adsorbed, even if the member is extremely thin.

The solvent used has preferably a boiling point higher than the melting point of the ultra-high-molecular-weight polyethylene particles and is low solubility (poor solvent) with the ultra-high-molecular-weight polyethylene particles.

The present invention exhibits the following effects by the means described above.

That is, the method of producing a porous sheet according to the present invention enables production of a porous sheet excellent in releasability, surface smoothness and air permeability having a microstructure with the shape of ultrahigh-molecular-weight polyethylene particles almost maintained with adjacent particles heat-fused with one another at their contact sites and non-contact sites serving as pores.

### BRIEF DESCRIPTION OF THE DRAWINGS

FIG. 1 is a scanning electron microgram of a section of a porous sheet obtained in Example 1.

FIG. 2 is a scanning electron microgram of a section of a porous sheet obtained in Comparative Example 1.

### DESCRIPTION OF THE EMBODIMENTS

First, the method of producing a porous sheet according to this embodiment is described. The production method comprises at least the steps consisting of: preparing a dispersion having ultrahigh-molecular-weight polyethylene (referred to hereinafter as “UHMWPE”) particles dispersed in a solvent; applying the dispersion onto a film to form a coating layer thereon; firing the coating layer; and removing the solvent contained in the coating layer.

First, UHMWPE particles selected depending on the object are dispersed in an arbitrary solvent. The UHMWPE particles are used in the present invention because a porous sheet obtained from the UHMWPE particles can be made excellent in abrasion resistance and impact resistance with low friction coefficient and can be produced at low costs. The molecular weight of UHMWPE is preferably 500,000 or more, particularly preferably 1,000,000 or more, from the viewpoint of abrasion resistance. Specific examples of UHMWPE include, for example, commercially available Mipelon (trade name, manufactured by Mitsui Chemicals, Inc.) and Hostalen GUR (trade name, manufactured by Ticona). The molecular weight refers to a measured value determined according to ASTMD4020 (viscosity method).

The average particle diameter of the UHMWPE particles can be determined suitably depending on applications etc. For reducing the surface roughness, the average particle diameter is preferably 100 μm or less, more preferably 50 μm or less. The surface smoothness of the porous sheet itself can thereby be improved. Accordingly, even if a member to be adsorbed is significantly flexible, the porous sheet upon suction fixation of the member to be adsorbed can prevent the surface state thereof from shape transferring onto the member to be adsorbed. However, when the average particle diameter is 1 μm or less, the porous sheet formed may have reduced air permeability or may be made free of pores. For preventing the porous sheet from being free of pores, the heating temperature should also be regulated in forming a porous sheet to make the process complicated. The average particle diameter of UHMWPE particles is preferably uniform. This is because the thickness and pore diameter of the porous sheet can be made uniform. The average particle diameter is a value determined in a Coulter counter system.

The shape of the UHMWPE particles can be appropriately established depending on applications etc. For example, when the UHMWPE particles are spherical or roughly spherical, the porous sheet has a structure having the UHMWPE particles arranged in plane and is thus contacted not via surface contact but via multipoint contact with a member to be adsorbed. As a result, the porous sheet can be obtained as a sheet of very small friction coefficient with a reduced contact area. The shape of the particles can be not only spherical or roughly spherical, but also potato-shaped, grape-shaped, etc. The shape of the UHMWPE particles is preferably uniform. This is because the thickness and pore diameter of the porous sheet can be made uniform.

The solvent is not particularly limited, and specific examples of the solvent include glycerin, ethylene glycol, polyethylene glycol, etc. Preferably, the solvent has a boiling point not lower than the melting point of the UHMWPE particles and is low solubility (poor solvent) with the UHMWPE particles. When the solvent has a boiling point lower than the melting point of the UHMWPE particles, the solvent is evaporated during sintering of the UHMWPE particles, and the particles are sintered in a gaseous phase. Sintering in a gaseous phase causes the UHMWPE particles to be fused and fluidized, thus causing shape deformation of the particles. As a result, the surface layer portion of the porous sheet is crushed to increase the contact area thereof with a member to be adsorbed, thus increasing the friction coefficient. When the solvent is excellent in compatibility with the UHMWPE particles, the UHMWPE particles are swollen and thus shape deformed. Preferably the solvent has a predetermined viscosity, specifically a viscosity of 0.1 to 20 Pa·s, from the viewpoint of workability. The viscosity is a value determined with a Brookfield viscometer. The number of revolutions in this measurement was 10 rpm.

Although the mixing ratio of the UHMWPE particles to the solvent is not particularly limited, the ratio of the solvent to the UHMWPE particles is preferably in the range of about 0.5 to 10 (volume ratio), more preferably in the range of 1 to 3.

A surfactant can be added to the dispersion. The dispersibility of the UHMWPE particles can thereby be improved. For the purpose of preventing generation of bubbles upon compounding the UHMWPE particles with the solvent, a defoaming agent may be added to the dispersion, or after compounding, the dispersion may be defoamed by a method such as vacuum defoaming.

Then, the dispersion is applied onto a film. This application can be carried out by a general method used for applying a viscous material. For example, a coating machine for applying a general adhesive can be mentioned, and a die system, a comma coater, a reverse coater etc. can be mentioned as a coating system. As an easier system, a system of using a jig such as an applicator or a doctor blade may also be used.

The thickness of a coating layer can be suitably established depending on the application object and on the size of the plastic particles contained in the dispersion. However, the thickness of the coating layer after sintering is preferably in the range of about 10 to 1000 μm, more preferably in the range of about 50 to 500 μm. When the thickness is less than 10 μm, in-plane arrangement of the plastic particles is made difficult in some cases. On the other hand, when the thickness is greater than 1000 μm, the air permeability may be lowered.

The film is preferably excellent in heat resistance and surface smoothness. When the film is selected from the viewpoint of heat resistance, the film may be suitably selected depending on the material of the plastic particles. For example, when the material of the plastic particles is UHMWPE or polypropylene particles, the film is preferably polyethylene terephthalate, polyimide or the like. This is because a film made of such material has sufficient heat resistance and a generally smooth surface. When the film is selected from the viewpoint of surface smoothness, the film can give excellent smoothness upon planarization of the sites at which the plastic particles contact with a support. It follows that upon suction and fixation of a member to be sucked, the adhesion of the sheet to the member to be sucked is improved.

The surface of the film may be subjected to hydrophilization treatment for improving affinity for the dispersion. The hydrophilization treatment can be exemplified by corona treatment, plasma treatment, hydrophilic monomer grafting treatment, etc.

Then, the coating layer is calcined by heating at a predetermined temperature. By doing so, the UHMWPE particles in the coating layer are sintered. The calcination temperature is preferably, for example, 130 to 200° C., more preferably 140 to 180° C. The calcination time may be suitably determined depending on the calcination temperature etc., and is, for example, about 1 minute to 1 hour. After sintering is carried out as described above, the coating layer is cooled. As the cooling method, a method of leaving it at room temperature after sintering or passing it through cooling rolls can be used. Alternatively, the process of from sintering to extraction can be continuously conducted, for example, by introducing the coating layer directly as such into an extraction bath.

Subsequently, the solvent contained in the coating layer is removed. Removal of the solvent can be carried out by extracting it with another solvent and drying it. Another solvent used in this extraction may be suitably selected depending on the type of the solvent described above. Specific examples include ethyl alcohol, methyl alcohol, deionized water, etc. A mixture of these solvents may also be used. The extraction can be carried out, for example, under vibration with ultrasonic waves or under heating. By doing so, the solvent can be extracted more efficiently. When vibration with ultrasonic waves etc. is applied, it is preferable that vibration with ultrasonic waves having frequencies of 10 to 200 kHz, for example, is carried out for 1 to 10 minutes. In the case of heating, it is preferable that heating is carried out, for example, at a temperature of 30 to 100° C. for 1 to 100 minutes.

The porous sheet made of UHMWPE obtained in this manner has a microstructure wherein as described above, the adjacent UHMWPE powders maintain their shape partially or wholly and are thermally fused mutually at their contacting sites to form a sheet, while the sites where the powders are not contacted with one another serve as pores. The microstructure of this porous sheet can be observed by cutting the porous sheet along the direction of thickness and then observing the resulting section under a scanning electron microscope (magnification can be suitably established and is usually about ×100 to ×1000).

Now, the porous sheet obtained by the production method of the present invention is described. The porous sheet can be used, for example, in suction fixation of a member to be adsorbed and is constituted by containing UHMWPE particles.

When the porous sheet is composed of UHMWPE, the thickness of the porous sheet can be suitably determined according to applications and is preferably in the range of 0.1 mm to 3.0 mm. When the thickness is less than 0.1 mm, the porous sheet is rendered poor in mechanical strength and broken at use in some cases, and the operativeness of fixing the porous sheet onto a laminating jig etc. may be lowered. On the other hand, when the thickness is greater than 3.0 mm, the air permeability of the porous sheet is lowered.

When the porous sheet is composed of UHMWPE, the porosity of the porous sheet can be determined suitably depending on applications and is preferably in the range of 10 to 70%. When the porosity is less than 10%, there is a tendency for the air permeability to be lowered and for the coefficient of friction to be increased. On the other hand, when the porosity is grater than 70%, the mechanical strength of the porous sheet is lowered. The porosity is calculated according to the following equation (1):

Porosity (%)={1−(apparent density/true specific gravity of UHMWPE)}×100 (1)

The porous sheet according to the present invention may be impregnated with an antistatic agent such as a surfactant or an electroconductive polymer in order to prevent electrification. Alternatively, carbon black or an electroconductive polymer is mixed at the time of molding to give antistatic properties. Alternatively, the sheet after cutting may be impregnated with an antistatic agent. Sparking resulting from electrification of the porous sheet can be prevented in a step of dicing a semiconductor wafer, and thus wafer damage attributable to sparking can be prevented. Further, the adhesion of dust to products to be processed such as semiconductor wafers can also be prevented.

The surface roughness (Ra) of the porous sheet is preferably 0.5 μm or less, more preferably in the range of 0.1 to 0.4 μm. When the surface roughness is greater than 0.5 μm, the surface is made rough and may, if a member to be sucked is extremely thin, cause damage to the member to be sucked. When the surface roughness is less than 0.1 μm, the surface is made smooth and may deteriorate releasability in releasing a member to be sucked. When the surface roughness (Ra) is 0.5 μm or less, the porous sheet can prevent a member to be sucked from slipping into pores of the layer even if the member to be sucked has low rigidity and is as very thin as a green sheet for laminated ceramic capacitor. As a result, the layer for suction and fixation can prevent the thin member to be sucked from having defects such as unevenness and damage and can also improve operativeness.

The porous sheet is a layer constituted by including plastic particles, thus fixing a member to be sucked by bringing the particle layer into contact with the member not through surface contact but through multipoint contact. The porous sheet is thereby made excellent in releasability and can, even if a member to be sucked is extremely thin, prevent the member from being broken or damaged upon releasing. In addition, the time required for suction and release of the member to be sucked, that is, the tact time in the production process, can be reduced. There are sites where adjacent UHMWPE particles are fused with one another (sintered) at points of contact.

The releasability of the porous sheet according to this embodiment is preferably as high as possible in order to release the sucked and fixed member after delivery. When this releasability is evaluated in terms of adhesion to a general pressure-sensitive adhesive tape (No. 31, manufactured by Nitto Denko Corporation), the adhesion of the sheet is preferably lower because the lower adhesion is indicative of higher releasability. Specifically, the adhesion is preferably not higher than 2.0 N/19 mm, more preferably not higher than 1.5 N/19 mm. When the adhesion is higher than 2.0 N/19 mm, the sucked member may remain on the surface of the porous sheet upon release of a dielectric sheet, to cause inconvenience in releasing. This adhesion tends to be decreased as the surface roughness is increased. It follows that when the adhesion is too low, the surface roughness is too high, thus causing damage to the sucked member to be sucked upon suction and fixation. From this point of view, the adhesion is preferably not lower than 0.3 N/19 mm.

The air permeability of the porous sheet according to this embodiment is preferably higher from the viewpoint of the problem of tact time for suction of the member to be sucked. Specifically, the air permeability determined by a Fragile testing machine is preferably not lower than 0.3 cm³/cm²·sec, more preferably not lower than 1.0 cm³/cm²·sec. When the air permeability is decreased, the tact time necessary for suction and fixation of a member to be sucked may be increased to lower productivity as described above.

The sheet for suction and fixation according to the present invention may be the porous sheet alone or may be a laminate having a plurality of laminated layers as other porous sheets different in pore diameter, strength, air permeability, etc. In this case, other porous sheet(s) is laminated at an opposite side to the suction side of the porous sheet. Other porous sheet(s) when laminated on the porous sheet can confer sufficient strength in addition to surface smoothness for suction and fixation for delivery.

Hereinafter, the invention is described in more detail by reference to the preferable embodiments of the invention. However, the materials, the amounts of the materials, etc. described in the Examples are merely illustrative of the invention unless otherwise specified, and are not intended to limit the scope of the invention.

### EXAMPLE 1

UHMWPE powder (average molecular weight, 2,000,000; melting point, 135° C.; average particle diameter, 30 μm; particle shape, spherical) was mixed with glycerin and a surfactant to prepare a dispersion. The solid content of the dispersion was 40 vol. %. Subsequently, this dispersion was applied by an applicator onto a PET film (trade name: Lumilar S10, thickness of 100 μm). The thickness of the coating layer (including the solvent) was 250 μm.

The resulting laminate having the coating layer formed on the PET film was introduced into a drying machine set at 150° C. and then kept still therein for 30 minutes. Thereafter, the laminate was removed and naturally cooled to room temperature. After the PET film was removed therefrom, the coating layer was dipped in ethyl alcohol to extract the dispersing solvent. For more efficient extraction of the dispersing solvent, the coating layer was vibrated with ultrasonic waves. The frequency of the ultrasonic waves was 38 Hz, and the vibration time was 10 minutes. Thereafter, the ethyl alcohol was volatilized at room temperature, whereby the porous sheet in this example was manufactured.

### COMPARATIVE EXAMPLE 1

The porous sheet in this comparative example was manufactured in the same manner as in Example 1 except that glycerin as the dispersing solvent used in Example 1 was replaced by deionized water.

### (Various Measurements and Evaluations)

The respective porous sheets prepared in the manner described above were measured for their surface roughness, thickness, air permeability and friction coefficient respectively, and their SEM photographs were observed. These results are shown in Table 1 below. The measurement methods and measurement conditions are as follows:

### [Surface Roughness]

The surface roughness of each porous sheet was determined with a probe-type surface sourness meter (Surfcom 550A, Tokyo Seimitsu Co., Ltd.). The measurement conditions were as follows: The tip diameter R was 250 μm, the speed was 0.3 mm/sec., and the measurement length was 4 mm.

### [Thickness]

The thickness of each porous sheet was measured with a 1/1000 micrometer.

### [Air Permeability]

The air permeability of each porous sheet was measured with a Frazier tester. The air permeability is a value of air permeability in the thickness direction of the whole porous sheet.

### [Coefficient of Friction]

Using a reciprocating dynamic friction testing machine (Baden-Leben friction testing machine) (AST-15B, manufactured by ORIENTEC Co., Ltd.) with a polyethylene terephthalate film (50 μm) as a partner material, the coefficient of dynamic friction was measured under the conditions of a test load of 200 g and a moving speed of 150 mm/min, to determine the average value.

### [Observation of SEM Photograph]

A section of the porous sheet was observed under a scanning electron microscope (SEM). The measurement conditions were a magnification of ×400 and an inclined surface at 15°.

TABLE 1

| | Surface | | Air | |
|---|---|---|---|---|
| | roughness | Thickness | permeability | Coefficient |
| | Ra (μm) | (mm) | (cm³/cm² · sec) | of friction |
| Example 1 | 0.3 | 0.15 | 10 | 0.13 |
| Comparative | 0.3 | 0.13 | 3 | 0.20 |
| Example 1 | | | | |

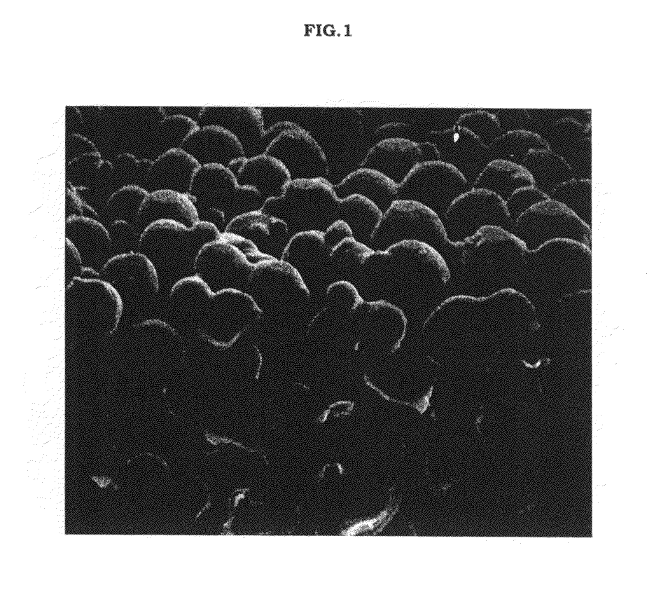

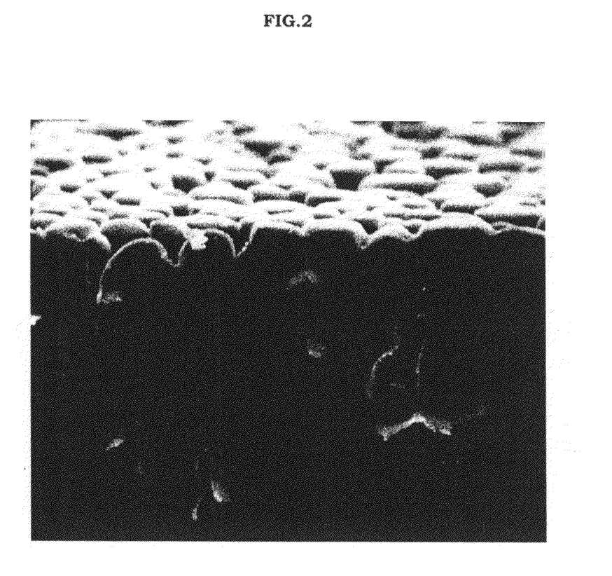

As is evident from Table 1, the porous sheet in Example 1 showed a surface roughness (Ra) of a low value of 0.3 μm and was thus confirmed to be excellent in surface smoothness. With respect to the surface state of the porous sheet, the UHMWPE particles maintained their spherical shape, as is evident from the SEM photograph shown in FIG. 1, and thus they were also confirmed to be excellent in air permeability. In the case of the porous sheet in Comparative Example 1, on the other hand, the surface thereof was smooth, but as evident from the SEM photograph shown in FIG. 2, the UHMWPE particles had crushed surfaces and were also low in air permeability.

1. A method of producing a porous sheet, comprising:
preparing a dispersion having ultra-high-molecular-weight polyethylene particles dispersed in a solvent,
applying the dispersion onto a film to form a coating layer thereon,
sintering the coating layer, and
removing the solvent contained in the coating layer.

2. The method of producing a porous sheet according to claim 1, wherein the ultra-high-molecular-weight polyethylene particles used are those having an average particle diameter of 100 μm or less.

3. The method of producing a porous sheet according to claim 1, wherein the solvent used has a boiling point higher than the melting point of the ultra-high-molecular-weight polyethylene particles and is low solubility with the ultra-high-molecular-weight polyethylene particles.

4. A porous sheet obtained by the method of producing a porous sheet according to claim 1, wherein the surface roughness (Ra) thereof is 0.5 μm or less.

5. The porous sheet according to claim 4, which is used in suction fixation of a member to be adsorbed.

6. The method according to claim 1, wherein said sintering step occurs at a calcination temperature of 130-200° C.

7. The method according to claim 3, further comprising extracting said solvent with a second solvent.

8. The method according to claim 1, wherein the thickness of the resulting porous sheet is from 0.1 mm to 3.0 mm.

9. The method according to claim 1, wherein the porosity of the resulting porous sheet is from 10% to 70%.

10. The method according to claim 4, wherein the Ra is 0.1 μm to 0.4 μm.

11. The method according to claim 1, wherein the adhesion of the resulting porous sheet is from 2.0 N/19 mm to 0.3 N/19 mm.

12. The method according to claim 1, wherein the air permeability of the resulting porous sheet is from 0.3 cm³/cm²·sec to 1.0 cm³/cm²·sec.

13. The method according to claim 1, wherein the ultra-high-molecular-weight polyethylene particles have an average particle diameter of 1-50 μm.

14. The method according to claim 1, wherein the thickness of the coating layer is from 10 μm to 1000 μm.

15. The method according to claim 1, wherein the dispersion further comprises a surfactant.

16. The method according to claim 1, wherein the resulting porous sheet further comprises an antistatic agent impregnated therein.

17. The method according to claim 3, wherein the viscosity of the solvent is 0.1-20 Pa·s.
